(19) United States
(12) Patent Application Publication
(10) Pub. No.: US 2010/0187428 A1
(43) Pub. Date: Jul. 29, 2010

(54) DIGITAL X-RAY IMAGING SYSTEM

(76) Inventor: Sanjay Tank, Bangalore (IN)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/359,674

(22) Filed: Jan. 26, 2009

(51) Int. Cl. G01T 1/24

(52) U.S. Cl. 250/370.09

(57) ABSTRACT

The invention relates to a digital X-ray imaging system, wherein the digital X-ray imaging system comprises a digital detector for detecting X-ray signals and for converting the detected intensity of X-ray signals into digital pixel values; and an intermediate storage arrangement adapted to receive and store the digital pixel values.

### FIELD OF INVENTION

The embodiments herein generally relate to radiography imaging systems, and, more particularly, to a digital X-ray imaging system.

### BACKGROUND OF INVENTION

Digital radiography is a form of X-ray imaging, where sensors are used instead of traditional photographic film. The X-ray signals propagated though an object are incident on the sensors. There are two general approaches of converting the intensity of the incident X-ray signals on the sensors, direct or indirect.

In the indirect approach, the intensity of X-ray signals is first converted into visible light using phosphorous screens. The visible light is then read out with additional light sensors, and the intensity of the visible light is converted into digital pixel values. In the direct approach, the intensity of the incident X-ray signals on the sensors is directly converted into digital pixel values.

The direct method offers the advantages of higher screen resolution, and elimination of the phosphorous screen.

### SUMMARY OF INVENTION

In view of the foregoing, an embodiment herein includes a digital X-ray imaging system, wherein the digital X-ray imaging system comprises a digital detector for detecting X-ray signals and for converting the detected intensity of X-ray signals into digital pixel values; and an intermediate storage arrangement adapted to receive and store the digital pixel values.

Preferably, the intermediate storage arrangement comprises a memory control circuit to receive digital pixel values from said detector; and a non-volatile memory operatively connected to said memory control circuit, wherein the memory control circuit writing digital pixel values to the non-volatile memory. Moreover, the digital X-ray imaging system may further comprise a central processing unit (CPU) coupled to the memory control circuit.

Preferably, the CPU reads the non-volatile memory and records the digital pixel values present in the non-volatile memory on a secondary memory. Additionally, the memory control circuit is configured to erase the digital pixel values written on the non-volatile memory. Moreover, the memory control circuit may be configured to determine an amount of free memory space available on the non-volatile memory; and cease from writing digital pixel values onto the non-volatile memory if there is no free memory space available.

Additionally, the digital X-ray system may further comprise means for visually indicating the amount of free memory space available on the non-volatile memory to a user. Preferably, the non-volatile memory is selected from the group including a solid state memory, a magnetic disk, an optical disk, an optical magnetic disk, a memory stick, and a read only memory (ROM) device. Preferably, the non-volatile memory is configured to operate in a first in first out mode.

Another embodiment includes a digital detector for detecting X-ray signals in a digital X-ray imaging system, wherein the digital detector comprises a detector panel to receive X-ray signals; an analog to digital (A/D) converter for converting the received X-ray signal intensities into digital pixel values; and an intermediate storage arrangement for storing the digital pixel values.

Yet another embodiment includes a digital X-ray imaging system, wherein the digital X-ray imaging system comprises a digital detector for detecting X-ray signals and for converting the detected intensity of X-ray signals into digital pixel values; a central processing unit (CPU) connected to the digital detector to receive the digital pixel values; and a non-volatile memory connected to the CPU, the CPU writing the digital pixel values to the non-volatile memory.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The present invention is further described hereinafter with reference to exemplary embodiments shown in the accompanying drawings, in which:

FIG. 1 illustrates a schematic block diagram of an X-ray imaging system in accordance with an embodiment herein; and

FIG. 2 illustrates a schematic block diagram of an X-ray imaging system in accordance with a second embodiment herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

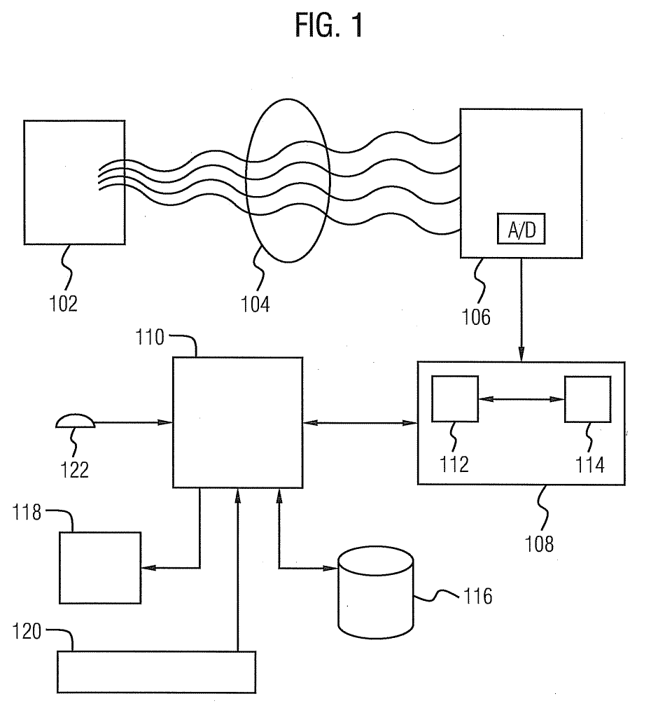

FIG. 1 illustrates a schematic block diagram of an X-ray imaging system in accordance with an embodiment herein. As, shown, an X-ray tube 102 is used as a source. The X-ray signals propagate through an object under study 104, for e.g., a patient, and thereafter are incident on a digital detector 106. The digital detector 106 comprises a detector plate or panel as well as reading, amplification, and (analog to digital) A/D conversion circuitry, arranged in a conventional manner. The digital detector 106 converts the incident X-ray signal intensities into an array of digital pixel values.

Depending upon the intensity of the incident X-ray signal, electrical charges generated either electrically or optically by the incident X-ray signal within a pixelized area are quantized using a regularly arranged array of discrete solid state radiation sensors. Accordingly, the digital detector 106 converts the incident X-ray signal intensities into an array of digital pixel values, in a manner known conventionally.

In accordance with the present embodiment, an intermediate storage arrangement 108 is provided between the digital detector 106 and a central processing unit (CPU) 110. The intermediate storage arrangement 108 comprises a memory control circuit 112 operatively connected to a non-volatile memory 114 (for e.g., a flash memory). The A/D conversion circuit converts the X-ray signal intensity incident on the digital detector 106 into digital pixel values, and then, outputs the converted digital pixel values to the memory control circuit 112. The memory control circuit 112 writes the digital pixel values to the non-volatile memory 114.

The CPU 110 is operatively connected to a secondary memory 116 for storing the digital pixel values. Generally, the secondary memory 116 is a hard disk. The CPU 110 is further coupled to user input/output (I/O) interfaces such as a display 118, keyboard 120, and mouse 122. The digital images corresponding to the digital pixel values can be displayed on the display 118. Further, the CPU 110 can read previously stored digital images from the secondary memory 116 and display digital images on the display 118. A user can key in commands to the CPU 110 through the input interfaces such as the keyboard 120 and/or mouse 122. The digital pixel values stored on the secondary memory 116 may be further processed by the CPU 110 to enhance the image quality.

The CPU 110 periodically reads the non-volatile memory 114 via the memory control circuit 112 to determine whether new digital pixel values corresponding to a new object are present. In case new digital pixel values are present, the CPU 110 acquires the digital pixel values from the non-volatile memory 114. The CPU 110, then, records the digital pixel values in a secondary memory 116. The CPU 110 reads the non-volatile memory 114 by sending a reading out request to the memory control unit 112.

Preferably, the non-volatile memory 114 is configured to operate in a first in first out mode. The digital pixel values which move into the non-volatile memory 114 first are the ones which move out first of the non-volatile memory 114 during the process of acquiring and recording of the digital pixel values by the CPU 110 on the secondary memory 116.

After successful acquisition of the digital pixel values from the non-volatile memory 114, in an embodiment the memory control circuit 112 may be configured to erase the digital pixel values which have been successfully acquired by the CPU 110, from the non-volatile memory 114. Alternatively, a user may send a request to erase command to the memory control circuit 112 to erase desired digital pixel values present on the non-volatile memory 114. The user may interact with the memory control circuit 112 to perform read/write operations on the non-volatile memory 114, via input interfaces such as a keyboard 120 and/or a mouse 122 interfaced with the CPU 110.

In an embodiment, the memory control circuit 112 is configured to determine an amount of free memory space available on the non-volatile memory 114. At circumstances, when the CPU 110 fails and there is no free memory space available on the non-volatile memory 114, as the contents of the non volatile memory 114 have not been acquired by the CPU 110, the memory control circuit 112 is configured to cease from writing further digital pixel values onto the non-volatile memory 114. The memory control circuit 112 may write further digital pixel values onto the non-volatile memory 114 after the digital pixel values present on the non-volatile memory 114 have been acquired by the CPU 110. This ensures that no digital pixel values corresponding to X-ray images taken already are lost.

Alternatively, the status of the free memory space available may be provided to a user though visual indications. In an embodiment, an indicator may be connected to the memory control circuit 112 and the memory control circuit 112 may be configured to provide the corresponding signal to the display for providing the indications. The indicator can be a light emitting diode (LED), a liquid crystal display (LCD) or any visual indicator.

The non-volatile memory 114 in the intermediate storage 108 is not limited to the flash memory. A variety of computer readable media such as a solid state memory, a magnetic disk, an optical disk, an optical magnetic disk, a memory stick, a read only memory (ROM), and combinations of electronic, magnetic and optical formats may be used. However, the access-time for magnetic memory storage devices and optical memory devices is more than the access-time for a solid state memory device. In an embodiment, when the non-volatile memory 114 is a solid state memory.

In accordance with an embodiment, where the non-volatile memory 114 is a flash memory, the non-volatile memory 114 may be removable from its existing arrangement and can be loaded into a memory card reader (not shown) connected to the a CPU 110. Accordingly, the CPU 110 can perform read/write operations on the non-volatile memory 114 loaded into the memory card reader. On the completion of acquisition and storage of the digital pixel values present in the non-volatile memory 114, into a secondary memory 116, the contents of non-volatile memory 114 may be erased by the CPU 110. The non-volatile memory 114 can then be re-arranged such that the memory control circuit 112 can perform read/write operations onto it. In another embodiment, where the non-volatile memory 114 is a memory stick, the memory may be removed from its existing arrangement and connected to a universal serial bus (USB) port of the CPU 110.

In accordance with another embodiment, the intermediate storage arrangement 108 comprising the memory control circuit 112 and the non-volatile memory 114 may be arranged internally within the digital detector 106. The memory control circuit 112 may receive the digital pixel values from the A/D conversion circuitry and write the digital pixel values to the non-volatile memory 114. The CPU 110 may read the non-volatile memory 114 via the memory control circuit 112 to determine whether new digital pixel values corresponding to a new object are present.

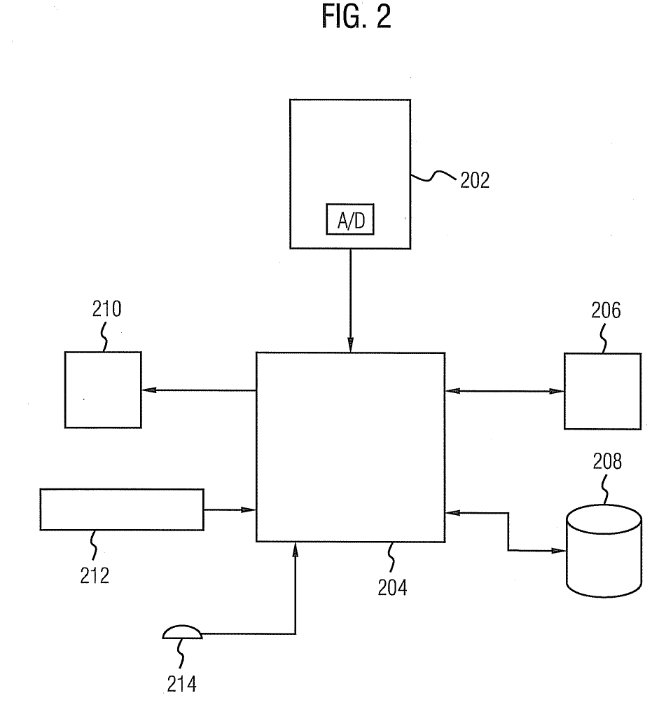

FIG. 2 illustrates a further modification of the arrangement of FIG. 1. Referring now to FIG. 2, a digital detector 202 receives X-ray signals propagated though an object under study. The digital detector 202 comprises the requisite reading, amplification, and A/D conversion circuitry to read and convert the incident X-ray signals intensity into digital pixel values, in a manner known conventionally. After conversion, the digital pixel values are provided to a CPU 204. The CPU 204 writes the digital pixel values to a non-volatile memory 206 connected to the CPU 204. Thereafter, the CPU 204 writes the digital pixel values to a secondary memory 208. The CPU 204 can also read the contents of the non-volatile memory 206 and store digital pixel values representing new images on the secondary memory 208. The CPU is coupled to I/O interfaces such as a display 210, a keyboard 212, and a mouse 214. The digital images can be displayed on the display 210. Commands from a user can be provided to the CPU 204 using the keyboard 212 and/or the mouse 214.

With the inclusion of an intermediate storage arrangement in accordance with the embodiments described herein, the possibility of loosing data relating to an X-ray image of an object in minimized. This ensures that in cases of failure of the CPU, an object is not required to undergo the process of X-ray imaging for a second time. This prevents patients from being over-exposed to X-ray radiations.

Further, the presence of a non-volatile memory provides additional advantage of storing digital pixel values at circumstances when the CPU has failed. Thus, X-ray images of objects can be taken in scenarios wherein the CPU has failed.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A digital X-ray imaging system, said digital X-ray imaging system comprising:
a digital detector for detecting X-ray signals and for converting the detected intensity of X-ray signals into digital pixel values; and
an intermediate storage arrangement adapted to receive and store the digital pixel values.

2. The digital X-ray imaging system according to claim 1, wherein said intermediate storage arrangement comprises:
a memory control circuit to receive the digital pixel values from said detector; and
a non-volatile memory operatively connected to said memory control circuit, said memory control circuit writing the digital pixel values to said non-volatile memory.

3. The digital X-ray imaging system according to claim 2, further comprising a central processing unit (CPU) coupled to said memory control circuit.

4. The digital X-ray imaging system according to claim 3, wherein said CPU reads said non-volatile memory and records the digital pixel values present in said non-volatile memory on a secondary memory.

5. The digital X-ray imaging system according to claim 2, wherein said memory control circuit is configured to erase the digital pixel values written on said non-volatile memory.

6. The digital X-ray imaging system according to claim 2, wherein said memory control circuit is configured to:
determine an amount of free memory space available on said non-volatile memory; and
cease from writing digital pixel values onto said non-volatile memory if there is no free memory space available.

7. The digital X-ray imaging system according to claim 6, further comprising means for visually indicating the amount of free memory space available on said non-volatile memory to a user.

8. The digital X-ray imaging system according to claim 2, wherein said non-volatile memory is selected from the group including a solid state memory, a magnetic disk, an optical disk, an optical magnetic disk, a memory stick, and a read only memory (ROM) device.

9. The digital X-ray imaging system according to claim 2, wherein said non-volatile memory is configured to operate in a first in first out mode.

10. A digital detector for detecting X-ray signals in a digital X-ray imaging system, said digital detector comprising:
a detector panel to receive X-ray signals;
an analog to digital (A/D) converter for converting the received X-ray signal intensities into digital pixel values; and
an intermediate storage arrangement for storing the digital pixel values.

11. The digital detector according to claim 10, wherein said intermediate storage arrangement comprises:
a memory control circuit to receive the digital pixel values from said detector; and
a non-volatile memory operatively connected to said memory control circuit, said memory control circuit writing the digital pixel values to said non-volatile memory.

12. The digital detector according to claim 11, wherein said memory control circuit is configured to erase the digital values written on said non-volatile memory.

13. The digital detector according to claim 11, wherein said memory control circuit is configured to:
determine an amount of free memory space available on said non-volatile memory; and
cease from writing digital pixel values onto said non-volatile memory if there is no free memory space available.

14. The digital detector according to claim 13, further comprising means for visually indicating the amount of free memory space available on said non-volatile memory to a user.

15. The digital detector according to claim 11, wherein said non-volatile memory is selected from the group including a solid state memory, a magnetic disk, an optical disk, an optical magnetic disk, a memory stick, and a read only memory (ROM) device.

16. The digital detector according to claim 11, wherein said non-volatile memory is configured to operate in a first in first out mode.

17. A digital X-ray imaging system, said digital X-ray imaging system comprising:
a digital detector for detecting X-ray signals and for converting the detected intensity of X-ray signals into digital pixel values;
a central processing unit (CPU) connected to said digital detector to receive the digital pixel values; and
a non-volatile memory connected to said CPU, said CPU writing the digital pixel values to said non-volatile memory.

18. The digital X-ray imaging system according to claim 17, wherein said CPU is further coupled to a secondary memory, said CPU recording contents of said non-volatile memory to said secondary memory.

19. The digital X-ray imaging system according to claim 17, wherein said CPU is configured to erase the digital values written to said non-volatile memory.

20. The digital X-ray imaging system according to claim 17, wherein said non-volatile memory is configured to operate in a first in first out mode.
